(19) United States
(12) Patent Application Publication
(10) Pub. No.: US 2003/0104110 A1
(43) Pub. Date: Jun. 5, 2003

(54) Heat treated, whippable oil in water emulsion

(76) Inventors: Rob Sikking, Aartselaar (BE); Linda Johanna Vermmer-Mols, Vlaardingen (NL)

Correspondence Address: UNILEVER, PATENT DEPARTMENT, 45 RIVER ROAD, EDGEWATER, NJ, 07020, US

(21) Appl. No.: 10/148,963

(22) PCT Filed: Dec. 1, 2000
(86) PCT No.: PCT/EP00/12082

(30) Foreign Application Priority Data
Dec. 10, 1999 (EP) 99204257.2

(51) Int. Cl. A23D 9/06; A23D 7/06

(52) U.S. Cl. 426/604; 426/564

(57) ABSTRACT

The invention relates to a heat treated, whippable oil in water emulsion comprising a fat phase and at least one emulsifier, whereby the fat phase comprises a fat blend, characterised in that the fat blend has a solid fat content of at least 10% at 40° C. and at least 40% at 30° C. and at least 60% at 10° C, and the fat blend comprises from 5 to 49 wt % fatty acids with 14 carbon atoms or less on total fatty acid content of the fat blend. The specific fat phase makes the composition stable upon storage at temperatures up to 35° C. while the composition still shows good whippability.

### FIELD OF THE INVENTION

The invention relates to a heat treated whippable oil in water emulsion comprising a fat phase and at least one emulsifier, whereby the fat phase comprises a specific fat blend.

The invention also relates to a process to prepare the oil in water emulsion.

### BACKGROUND

There is a desire for whippable oil in water emulsions which can be stored at temperatures from 20 to 40° C., without showing microbiological spoilage or other storage defects.

Examples of whippable oil in water emulsions are whippable creams. Whippable creams are for example encountered as toppings and fillings for cakes, as filling for pastry like eclairs, creme pies or donuts, and as desserts or cooking creams. These products can be used in the whipped or unwhipped state.

Oil in water emulsions can be heat treated, for example at temperatures from 70 to 160° C. for 1 second to 60 minutes, to improve microbiological stability. Heat treated oil in water emulsions are known in the art.

WO-A-95/21535 discloses heat treated oil in water emulsions comprising an emulsifier, which emulsions show improved whipping characteristics and longer shelf life under refrigerated conditions, freezer conditions or ambient temperature. The oil phase comprises a triglyceride fat component wherein at least about 50% or more of the fatty acids thereof are of C14 length or less. The triglyceride fat component has a profile of solid fat index of about 70 at 10° C., about 40 to 75 at 26.7° C. and less than about 20 at 37.8° C.

Applicants have found that products according to WO-A-95/21535 show insufficient storage stability at temperatures above room temperature i.e. between 20 and 45° C.

Furthermore EP-A-563,593 discloses oil in water type emulsions containing from 5 to 70 wt % of a mixed fatty acid triglyceride containing at least one saturated fatty acid residue with 20 to 24 carbon atoms and at least one unsaturated fatty acid residue with 18 carbon atoms per molecule as constituting fatty acids. However products according to EP 563,593 are not preferred from a healthy point of view (saturated fat) and the emulsions are believed not to be stable upon storage at 20 to 40° C.

Storage stable products fulfil the following requirements.

1. General Tests

a) Viscosity three days after preparation and storage at 5° C., is between 30 and 300 mPa.s at 5° C.

b) The stored oil in water emulsion after whipping shows sufficient hardness which is exemplified by a hardness value after whipping for 1.5 to 4 minutes at 5 to 10° C. with Hobart N50 mixer at high speed (3) until the maximum resistance of the whipped product is reached. The hardness value as determined by the method according to the examples is from 10 to 500 g, preferably from 80 to 300 g at 5° C. The maximum resistance is determined by the potentiometer method defined in the examples.

c) Preferably after storage at 30° C. for 2 weeks or at 35° C. for 4 weeks, the oil in water emulsion does not show a grainy, firm mouthfeel but a soft, creamy mouthfeel.

2. Storage Stability Tests After Storage at 30° C. for Two Weeks

d) Viscosity shows a viscosity index of maximum 300%. The viscosity index is defined as the viscosity measured at 5° C., after storage as indicated, divided by the viscosity measured three days after preparation of the product and storage at 5° C. Heat treated oil in water emulsions preferably show a viscosity index of at most 200%, preferably not more than 150% after storage at 30° C. for 2 weeks and cooling back to 5° C. before measurement. The viscosity that is used to calculate the viscosity index is measured by the Carrimed method which is defined in the examples.

e) The oil in water emulsion does not show pellet formation. These pellets, if formed are easily identified in the oil in water emulsion as clotted, undissolved structures with an average diameter of 0.5 to 20 mm.

f) Hardness of the whipped oil in water emulsion is at least 10 g at 5° C., preferably from 20 to 500 g at 5° C.

g) the water in oil emulsion shows creaming of at most 1 cm in a 500 ml glass container of about 8 cm diameter. Creaming is the separation of an emulsion in two layers whereby a top layer comprises a thickened phase compared to the other layer in the product. The top layer can be identified by eye. The toplayer of fat may be liquid, viscous or more or less solid, depending on the triglyceride composition and the storage temperature. The amount of creaming can be determined by measuring the height of the top layer. Stable products show at most 1 cm, preferably less than 5 mm of creaming in a container of 500 ml with 8 cm diameter.

h) whipping times needed to reach a specific volume of between about 1.3 ml/g to 4.5 ml/g, also after storage, are in the order of from 30 seconds to 10 minutes

3. Storage Stability Tests After Storage at 35° C. for 4 Weeks

i) viscosity index of the oil in water emulsion as defined above, (measured at 5° C.) the oil in water emulsion is less than 300%.

j) The oil in water emulsion shows pellet formation of at most 3 on a scale of 1 to 5 determined by the method explained in the examples.

All above-indicated evaluations are carried out after the product has been stored at 5° C. for at least 24 hours. Products disclosed in WO-A-95/21535 are not stable upon storage do not fulfil test (d) and (i).

It is an object of the invention to provide a heat treated whippable oil in water emulsion, which emulsion is stable upon storage at 20-40° C. These products are stable in that they fulfil tests (a-b) and (d-j) and preferably also test (c) indicated above.

### STATEMENT OF INVENTION

It has now been found that stable, heat treated oil in water emulsions are obtained if the fat phase of the oil in water emulsion has a solid fat content of at least 10% at 40° C. and at least 40% at 30° C. and at least 60% at 10° C., and the fat blend comprises from 5 to 49 wt % fatty acids with 14 carbon atoms or less on total fatty acid content of the fat blend.

Therefore the invention relates to a heat treated, whippable oil in water emulsion comprising a fat phase and at least one emulsifier, whereby the fat phase comprises a fat blend, wherein the fat blend has a solid fat content of at least 10% at 40° C. and at least 40% at 30° C. and at least 60% at 10° C., and the fat blend comprises from 5 to 49 wt % fatty acids with 14 carbon atoms or less on total fatty acid content of the fat blend.

### DETAILED DESCRIPTION OF THE INVENTION

The terms “fats” and “oils” are used interchangeably in this description.

The term N line is used to indicate the solids content of the fat phase at varying temperatures. The method to determine solid fat content is described in the examples. The solid fat content is different from the solid fat index. The method to determine solid fat index is referred to in Food engineering December 1993, page 23-24 and AOCS official method Cd10-57 as reapproved 1997, page 1-4.

For the purpose of the invention a whippable product is defined as a product with a specific volume of between 1.3 and 4.5 ml/g after whipping with a Hobart N50 mixer at high speed (speed 3). The method of whipping is described in the examples (see test k and l) and is applicable for all whipping determinations in this application. Products according to the invention are whippable within 30 seconds to 10 minutes at about 5 to 10° C. More preferred are whip times of between 1 minute and 4 minutes.

Another advantage of the claimed compositions is their whippability within 30 seconds to 10 minutes at temperatures of about 20° C., without the need for cooling to 5° C. before whipping.

The fat phase of products according to the invention comprises a fat blend, wherein the fat blend has a solid fat content of at least 10% at 40° C. and at least 40% at 30° C. and at least 60% at 10° C., and the fat blend comprises from 5 to 49 wt % fatty acids with 14 carbon atoms or less on total fatty acid content of the fat blend.

Fatty acids with 14 carbon atoms or less are generally fatty acids with 10 to 14 carbon atoms, although fatty acids with smaller amounts of carbon atoms for example 6 or 8 are also possible but occur less frequently.

If the solid fat content of the fat blend at the indicated temperatures is lower than the indicated values, products result that do not fulfil tests (a-b) and (d-j) indicated-above.

We have found that fat phases comprising 50 wt % or more of fatty acids with at most 14 carbon atoms (C14), lead to emulsions which show an undesired increase of viscosity if stored at 30° C. for 2 weeks or more (test d). Products prepared from a fat phase which comprised less than 5 wt % of fatty acids with 14 carbon atoms or less, were found to show soft products after whipping. Moreover these products show low specific volume of below 1.3 ml/g after whipping the products after storage at 35° C. for 4 weeks.

Preferred oil in water emulsions comprise a fat blend which shows a solid fat content of from 13% to 45% at 40° C., from 45% to 80% at 30° C. and at least 60% at 10° C., more preferred from 80% to 100% at 10° C.

Even more preferred, the fat blend comprises from 10 to 49 wt %, more preferred from 20 to 45 wt %, even more preferred from 35 to 47 wt %, most preferred 39 to 46 wt % fatty acids with 14 carbon atoms or less on total fatty acid content of the fat blend.

Most preferred a fat phase is used which shows these characteristics in combination with a solid fat content at 37° C. of from 25% to 45%, preferably from 35% to 42%. Such roducts show acceptable oral melting behavior.

The N line of the fat blend is preferably not steep but flat in the temperature range between 30 and 35° C. Therefore according to a preferred embodiment, the fat blend is characterised by a difference (D) between the solid fat content at 30° C. and the solid fat content at 35° C. of between 1% and 50%, preferably from 10 to 35%.

The difference (D) in (%) is calculated as follows: The solid fat content at 30° C. (%) (X) minus the solid fat content at 35° C. (%) (Y) is divided by the solid fat content at 30° C. and the result is multiplied with 100%.

D=(^{(X-Y)}/X)*100%

The difference D(2) as defined below is a measure for the relation between physical satbility and oral melting behaviour of the current compositions.

Even more preferred the difference D(2) as specified below is between 35% and 75%, more preferred from 45% to 65%.

D(2)=(^{(A-B)}/A)*100%

Wherein A is the solid fat content at 20° C. (%) and B is the solid fat content at 35° C. (%).

All suitable combinations of fats such that the above requirements regarding solid fat content and wt % fatty acids with 14 carbon atoms or less, are fulfilled can be applied in products according to the invention.

Although applicants are aware that there are many possible combinations of triglyceride fats which lead to a fat blend with the desired N line and other characteristics indicated above, we have found that a specific combination is especially favourable and leads to products with even further improved storage stability.

Therefore in addition to triglycerides with fatty acids with 14 carbon atoms or less, the fat blend preferably comprises triglycerides with fully hydrogenated fatty acids with 16 or 18 carbon atoms.

The triglyceride fats comprising C16 and/or C18 fatty acids generally show a relatively high melting point compared to triglyceride fats comprising mainly fatty acids of 14 carbon atoms or less. Therefore the former are also referred to as high melting triglyceride fats and the latter are referred to as low melting triglyceride fats.

Preferred amounts of the high melting triglyceride fats are such that the high melting fats support the N line characteristics that are desired. For example the amount of high melting triglyceride fats is from 20 to 50 wt % on fat blend.

The low melting triglyceride fat, with a high content of fatty acids of 14 carbon atoms or less, can for example be selected from the group comprising coconut oil, palmkernel oil, babassu oil, hardened palmkernel, hardened coconut, hardened babusa and not hardened or mildly hardened oils such as maisoil, avocado oil, sesam oil, lineseed oil, safflower seed oil, nigerseed oil, borneatalg, walnut oil, rice oil, rapeseed oil, bean oil, palm oil, olive oil, sunflower oil, fish oil, cottonseed oil, whale oil and groundnut oil or combinations thereof.

The high melting triglyceride fat is preferably selected from the group comprising medium or fully hardened triglyceride fats for example selected from the group comprising rapeseed oil, bean oil, palm oil, palm oil stearine, olive oil, sunflower oil, fish oil, cottonseed oil, whale oil, groundnut oil, maisoil, avocado oil, sesam oil, lineseed oil, safflowerseed oil, nigerseed oil, borneatalg, walnut oil, rice oil, animal fat (e.g. lard, butter) and/or combinations thereof.

Preferably these triglyceride fats if used, are partially or fully hardened such that the slip melting point of the fats is in the range of 35 to 70° C.

Optionally the fats are subjected to interesterification.

The triglyceride fats with fully hardened C16 and C18 fatty acids are preferred over the C20 and longer chained fatty acids for health reasons and because they are believed to give a better mouthfeel than those longer chained fatty acids.

It has been found that fat phases comprising fully or partially hardened palm oil or palm oil stearine; fully or partially hardened palm kernel oil and/or fully or partially hardened coconut oil are especially suitable for use in products according to the invention.

Preferably the fat blend comprises an interesterified fat blend, preferably an interesterified fat mixture of fully hardened palmkernel oil and fully hardened palm oil or palm oil stearine. Highly preferred the fat blend consists of this interesterified blend.

Combinations of two or more interesterified fat blends were also found to be suitable.

The amount of fat phase in oil in water emulsions according to the invention is preferably from 18 to 40 wt %, more preferred 22 to 35 wt %.

Preferably the oil in water emulsions of the invention are pourable emulsions. Pourable means that the emulsion is a liquid (rather than a paste) and that it can be removed from its container by tilting the container, whereby the emulsion flows out. Suitably, the emulsion will have a viscosity in the range of 30-300 mPa.s when measured with a Haake viscosimeter type VT02, measured with head No.3, in measure beaker No.3 at a temperature of 5° C., measured after 20 seconds, rotation speed being 62.5 rotations per minute (rpm). The measurement is to be carried out 3 days after preparation of the emulsion and storage at 5° C.

Alternatively the viscosity can be measured by the Carrimed method as applied in the examples. The viscosity thus measured is preferably between 30 and 300 mPa.s at 5° C. at a shear rate of 100 s⁻¹.

Products according to the invention are storage stable in that they fulfil general tests a, b, and storage stability tests after storage at 30° C. for two weeks: d, e, f, g, h and storage stability tests after storage at 35° C. for 4 weeks i, j as indicated above. Preferably also test (c) is fulfilled.

Preferably the viscosity as determined in test (a), three days after preparation and storage at 5° C. is between 100 and 300 mPa.s at 5° C.

The hardness as determined in test (b) is preferably from 80 to 300 g at 5° C.

Regarding pellet formation as mentioned in test (e), the pellet formation can be determined on the basis of the method indicated in the examples.

With respect to test (j) after storage at 35° C. for 4 weeks, pellet formation is at most 3, preferably 0 to 2, most preferred 0 as determined by the method according to the examples.

Products according to the invention comprise emulsifiers. Preferred emulsifiers are selected from the group of proteins and low molecular weight emulsifiers or combinations thereof.

Proteins which can suitably serve as emulsifier are whey proteins, casein, soy protein, egg protein or combinations thereof.

The level of proteins for emulsification is preferably from 0.5 to 5 wt %, more preferably from 0.8 wt % to 3 wt % on total product weight.

The low molecular weight emulsifier can be any kind of known emulsifier. Preferably emulsifiers are selected from the group comprising mono- di- or polyglycerides of fatty acids, calcium or sodium stearoyl lactylates and all sucrose esters thereof, esters of lactic, citric and tartaric acids with the mono- and diglycerides of fatty acids, polyoxyethylene ethers of sorbitan stearates, polyglycerol esters, lecithins, and combinations of these emulsifiers.

The emulsifiers are preferably present in total amounts of 0.01-2.0 wt. %, more preferred 0.1-1.5 wt. %.

Thickeners may also be present in the emulsion. Although all known types of thickeners can be used, preferred thickeners are e.g. locust bean gum, guar gum, starch, alginate, carrageenan, cellulose and its derivatives. Suitable amounts of thickener are from 0.01 to 5 wt. %, preferably from 0.01 to 0.5 wt. %.

The taste of emulsions is often found to be rather bland. In order to improve the taste and to give it a dairy impression, 0.5-10 wt. %, preferably 1-5 wt. % of a milk protein source such as skimmed milk powder, sodium caseinate, a whey powder concentrate or buttermilk powder can be added to the water phase of the emulsion. This amount of milk protein source is including the protein which may be present as emulsifier.

Optionally emulsions according to the invention comprise one or more sugars such as sucrose, glucose, fructose, lactose, maltose, hydrolysed sugars or sweeteners like sorbitol.

Sugars are preferably present in amount of from 0.5 to 40 wt %. More preferred amounts are from 15 to 35 wt %.

Salts such as potassium chloride, sodium chloride and/or buffering salts like phosphates, citrates such as disodiumhydrogen phosphate, trisodium citrate may be added to the emulsion.

The pH of products according to the invention is preferably from 6 to 7.5, more preferably from 6.2 to 7.4

The products according to the invention may be prepared by any suitable process. According to a preferred embodiment of the invention, an emulsion of triglyceride fat and a premix comprising water, emulsifier and optionally another ingredient for example selected from the group comprising proteins, stabilisers, salts, sugar, flavour and combinations thereof, is prepared, heat treated at a temperature of from 70 to 160° C. for 1 second to 60 minutes, and filled into packaging material under aseptic conditions.

According to an even more preferred embodiment, this process comprises the following steps:

a) making a premix of the fats, emulsifier, water and optionally other ingredients like protein, thickener, sugar;

b) heating the premix to 55-90° C.;

c) sterilizing or pasteurizing the heated premix by UHT treatment, by heating to 70-160° C. for 1 second to 60 minutes

d) cooling the sterilized premix to 40-60° C.;

e) homogenizing the cooled premix under high pressure, either in a single stage or in a multi-stage process.

Pressures that can be applied range for example from 50-300 bar, preferably 65-250 bar;

f) cooling the homogenized mixture to 0-30° C.;

g) aseptically filling a container with the cooled, homogenized emulsion at 0-30° C.

The resulting emulsions can subsequently be stored at any temperature between 5 and 40° C., depending on the formulation and distribution requirements.

In the above-indicated, preferred process, the premix is heated to a temperature of from 55 to 90° C. before sterilisation or pasteurisation. Sterilisation is preferred in view of microbiological stability. The sterilisation is preferably carried out as a UHT treatment by indirect heating via a tubular heat exchanger or by injecting steam of high temperature (130-150 ° C.) during a short time of for example less than 30 seconds, preferably 1-6 seconds.

The homogenisation before packaging is preferably carried out, while the emulsion is above the melting temperature of the fat phase used. Preferred are temperatures of from 50-90° C.

The invention will now be illustrated by the following examples.

### EXAMPLES

General Methods

1. Viscosity Determination

1a: Carrimed Method

Apparatus used was a Carrimed CLS 50 rheometer with 6° steel cone setting. The measurement temperature was 5° C.

Shear rate was increased in 5 minutes from 0 to 100 s⁻¹ and back, while measuring the shear stress.

Viscosity (Pa.s) is determined as shear stress/shear rate at a shear rate of 100 ⁻¹.

1b: Haake Method

Haake viscosimeter type VT02 was used supplied with head No.3, in measure beaker No.3 at a temperature of 5° C. The viscosity was measured after 20 seconds, at a rotation speed of 62.5 rotations per minute (rpm). The measurement is to be carried out after 3 days storage at 5° C.

2. Measurement of Hardness

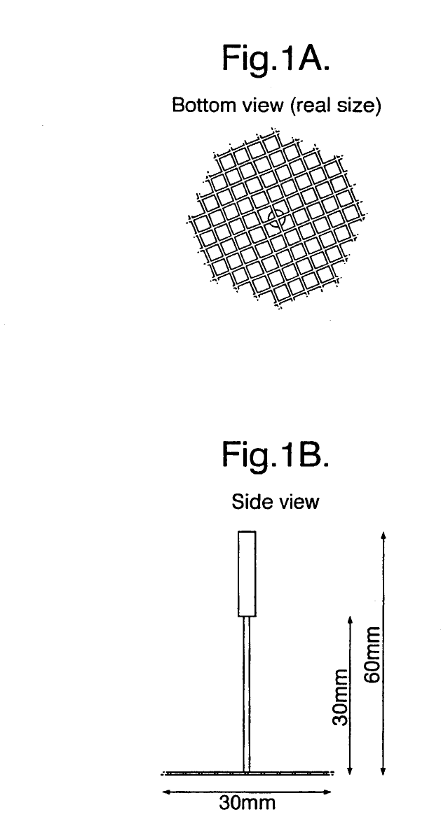

Apparatus used: Stevens Texture Analyser model LFRA Probe used: octagon shaped steel grid with 78 grids of grid size 2.8*2.8 mm, steel diameter 0.8 mm and open grids at four sides of the octagon. The grid is shown in FIG. 1, where in the bottom view (1A) of the probe is connected (perpendicular) to a holder as shown in FIG. 1(b) in side view.

Cuplet: 75 mm diameter and 45 mm depth

Settings of the Stevens Texture analyser:

Penetration depth: 20 mm

Penetration speed: 1 mm/sec

The hardness value is determined in grams.

The temperature is 5° C.

3. Whip Time Determination

A Hobart N50 mixer is connected with a potentiometer. 300 grams of emulsion were added (5° C.) to the 5 litre bowl of the Hobart N50 mixer with wire whisk attachment. The emulsion is whipped at high speed (3) until the power input recorded with the potentiometer is at maximum. The time required to obtain an optimum in the resistance determined by the potentiometer is the whip time.

4. Determination of Specific Volume (S.V.)

The specific volume of the whipped emulsion was measured by filling a steel cup with known volume and weight and levelling the top. The weight of the filled cup was measured.

S.V. is the volume of the whipped emulsion in the cup divided by the weight of whipped emulsion in cup (ml/g).

5. Pellet Formation

The emulsion was stored in a glass jar of 750 ml and a diameter of about 8 cm at the temperature and for the time indicated in the respective examples.

Pellet formation was determined by eye and the amount was determined by comparison with a reference wherein

0 corresponds to no pellets visible

1 corresponds to very small lumps of pellet of 0.5 to 2 mm visible

2 corresponds to small pellet has formed on top of size of about 2 to 20 mm

3 corresponds to a large pellet of size above 30 mm which has formed on top of the emulsion

4 corresponds to the situation that one coagulated mass has formed as a top layer, covering the whole surface of the jar

5 corresponds to the situation that to indicate that the emulsion is no longer pourable but has thickened to a very viscous mass.

6. Creaming is Determined as Follows:

500 ml of the product is stored in a 500 ml container with diameter of about 8 cm.

Creaming is the separation of an emulsion in two layers whereby a top layer comprises a thickened phase compared to the other layer in the product. The top layer can be identified by eye. The toplayer of fat may be liquid, viscous or more or less solid, depending on the triglyceride composition and the storage temperature. The amount of creaming can be determined by measuring the height of the top layer.

7. The solid fat content can be measured by a suitable analytical method such as NMR. The method used is low resolution NMR with Bruker Minispec apparatus. Reference is made to the Bruker minispec application notes 4, 5 and 6.

The percentage of solid fat determined by the low resolution NMR technique is defined as the ratio of the response obtained from the hydrogen nuclei in the solid phase and the response arising from all the hydrogen nuclei in the sample. The product of this ratio and one hundred is termed the low resolution NMR solids percent. No correction is made for variations in the proton density between solid and liquid phase. The NMR solids percent for a sample measured at t° C. was given the symbol Nₜ.

Suitable instruments adapted to determine the solids fat content are the Bruker Minispecs p20i™, pc20™, pc120™, pc120s™, NMS120™ and MQ20™.

Stabilisation and tempering procedure was as follows:

melt fat at 80° C.

5 minutes at 60° C.

60 minutes at 0° C.

30-35 minutes at each chosen measuring temperature.

Process

Ingredients and amounts are as indicated in the Examples. The process for preparing was as follows.

An aqueous phase was prepared by heating water to 75° C. Protein, sugar, gums or other ingredients were added.

The mixture was treated in an Ultra turrax™ for 5 minutes. A fat phase was prepared by heating the fat blend to 75° C. Emulsifiers were added to the heated fat blend and the resulting mixture was stirred together with a blade stirrer for 5 minutes.

The fat phase and the aqueous phase as prepared above were mixed at 75° C. and subjected to treatment in an Ultra Turrax™ for at least 2 minutes until a homogeneous emulsion resulted.

In further processing the resulting mixture (pre-mix) was pre-heated to 80° C. and subjected to direct steam injection to 142° C., while holding for 5 seconds. The resulting mixture was flash cooled to 80° C. and homogenised in one step at 200 Bar (1 step in a APV Gaulin homogeniser). The mixture was then cooled to 5° C. and filled aseptically in sterile glass jars.

Storage temperatures were subsequently at 5, 30 or 35° C. as indicated in the Examples.

### Examples 1-4

An emulsion with the following ingredient composition was prepared by the process described above and analysed for its stability upon storage.

Composition of This Emulsion:

| | | |
|---|---|---|
| Fat blend | 26.6 | wt % |
| Sugar | 20.00 | wt % |
| Milk powders (Skim milk powder, sodium caseinate) | 2.00 | wt % |
| Emulsifiers | 0.35 | wt % |
| (tween 60, SSL (sodium stearoyl lactylate)) | | |
| Salts (Na₂HPO₄, NaCL) | 0.4 | wt % |
| Thickeners (Methyl cellulose, guar) | 0.17 | wt % |
| Water | up to 100 | wt % |

The fat blend was varied.

In example 1 (according to the invention) a fat blend was used comprising a mixture of 75 wt % interesterified blend of fully hardened palm kernel oil and fully hardened palm oil in a ratio of 60 to 40 and 25 wt % hardened palmkernel oil with a slip melting point of 39° C. which fat blend was characterised by

N line of N10 of 96%, N20 of 91.2%, N30 of 62%, N35 of 36% and N40 of 13.5%.

Difference D: 42%, D(2) : 61%

Fatty acid composition:

C14 or less: 48% , hardened C16 and C18: 51%

In example 2 (according to the invention) a fat blend was used comprising a mixture of 100 wt % interesterified blend of fully hardened palm kernel oil and fully hardened palm oil in a weight ratio of 60 to 40 which fat blend was characterised by

An N line of N10 of 96%, N20 of 93.1%, N30 of 72%, N35 of 50% and N40 of 23%.

Difference D: 30%, D(2): 46%

Fatty acid composition:

C14 or less: 41% , hardened C16 and C18: 56%

In example 3(according to the invention) a fat blend was used comprising a mixture of 65 wt % fully hardened palm kernel oil and 35 wt % fully hardened palm oil (slip melting point 58° C.), which fat blend was characterised by

Difference (D): 24.3%, D(2): 50%

an N line of N10 of 95%, N20 of 90.0%, N30 of 58%, N35 of 45% and N40 of 39%.

Fatty acid composition:

C14 or less: 46%, hardened C16 and C18: 54%

In example 4 (according to the invention) a fat blend was used comprising a mixture of 45 wt % interesterified blend of fully hardened palm kernel oil and fully hardened palm oil in a weight ratio of 60 to 40 and 55 wt % of an interesterified blend of palm oil stearine (slip melting point of 53° C.) and rapeseed oil in a weight ratio of 80 to 20.

Fatty acid composition:

C14 or less: 20%, hardened C16 and C18: 55%

Solid fat content: N10: 80.9%, N20: 65%, N30: 40%, N35: 26% and N40: 21%

Difference (D): 50%. D(2): 60.3%.

### Comparative Examples

In example CI (comparative example; not according to the invention) a fat blend was used comprising 100 wt % fully hydrogenated palmkernel oil with a slip melting point of about 39° C. The fat blend was characterised by

Fatty acid composition:

C14 or less: 70% , hardened C16 and C18: 27%

Solid fat content at 40° C.: 4.8 and at 30° C.: 35, at 20° C.: 86%, at 35° C.: 13%.

Difference (D) : 63%. D(2) : 85%

In example C2 (comparative example, not according to the invention) a fat blend was used comprising coconut oil. This fat blend was characterised by

Fatty acid composition:

C14 or less: 80% hardened C16 and C18: 13%

Solid fat content: N20: 38%, N30: 0%, N35: 0%.

Difference D: 0% D(2): 100%

In comparative example C3 (comparative example, not according to the invention), a fat blend was used comprising 61 wt % bean oil with a slip melting point of 35° C. and 39 wt % fully hardened palm oil with a slip melting point of 58° C.

Solid fat content: N20: 81%, N30: 64%, N35: 54%, N40: 44%

D(2): 33%

Fatty acid composition:

C14 or less: 0%

In example C4 (comparative example, not according to the invention) a fat blend was used comprising 93 wt % fully hardened palmkernel oil with a slip melting point of 39° C. and 7 wt % palm oil with a slip melting point of 58° C.

Solid fat content: N10: 93.6%, N20: 84%, N30: 40.8%, N35: 19.5%, N40: 10.9%

Fatty acid composition:

C14 or less: 65% hardened C16 and C18: 33%

D(2): 77%

In the table below the emulsion characteristics are presented.

TABLE 1
summary of results tests (a-l)

| | 1 | 2 | 3 | 4 | C1 | C2 | C3 | C4 |
|---|---|---|---|---|---|---|---|---|
| (a) | 75 | 80 | 121 | 87 | 65 | 50 | 104 | 69 |
| Viscosity | | | | | | | | |
| after 3 days | | | | | | | | |
| after | | | | | | | | |
| preparation | | | | | | | | |
| (mPa . s) | | | | | | | | |
| (b) hardness | 125 | 200 | 158 | 80 | 180 | n.d. | 135 | 140 |
| (g) after | | | | | | | | |
| whipping | | | | | | | | |
| directly | | | | | | | | |
| after | | | | | | | | |
| preparation, | | | | | | | | |
| 5° C. | | | | | | | | |
| (c) | Not | Not | Not | Not | Very | n.d. | n.d. | n.d. |
| Mouthfeel | grainy | grainy | grainy | grainy | firm | | | |
| after | | | | | and | | | |
| storage | | | | | grainy | | | |
| (d) | 128% | 113% | 142% | 107 | 300% | 110% | 138% | 252 |
| Viscosity | | | | | | | | |
| index after | | | | | | | | |
| storage at | | | | | | | | |
| 30° C. for 2 | | | | | | | | |
| weeks | | | | | | | | |
| (mPa . s) | | | | | | | | |
| (e) Pellet | 0 | 0 | n.d. | 0 | 5 | 0 | 0 | 0 |
| formation, | | | | | | | | |
| storage for | | | | | | | | |
| 2 weeks at | | | | | | | | |
| 30° C. | | | | | | | | |
| (k) Specific | 2.6 | 2.9 | 3.3 | 2.9 | 2.5 | 1.4 | 2.4 | 2.9 |
| volume ml/g | | | | | | | | |
| after | | | | | | | | |
| storage 2 | | | | | | | | |
| weeks, 30° C. | | | | | | | | |
| (f) hardness | 142 | 135 | 162 | 103 | 300 | 95 | 147 | 184 |
| after | | | | | | | | |
| whipping and | | | | | | | | |
| storage 3 | | | | | | | | |
| weeks at | | | | | | | | |
| 30° C. (g) | | | | | | | | |
| (g) creaming | no | no | no | No | no | Severe; | n.d. | No |
| after | | | | | | about | | |
| storage for | | | | | | 2 | | |
| 2 weeks at | | | | | | cm | | |
| 30° C. | | | | | | | | |
| (h) Whip | 105 | 115 | 90 | 95 | 55 | >480 | 145 | 68 |
| time (sec) | | | | | | | | |
| after | | | | | | | | |
| storage 2 | | | | | | | | |
| weeks at | | | | | | | | |
| 30° C. | | | | | | | | |
| (i) | 225% | 143% | n.d. | 207% | >>300% | n.d. | 162% | 393 |
| viscosity | | | | | | | | |
| index after | | | | | | | | |
| 4 weeks at | | | | | | | | |
| 35° C. | | | | | | | | |
| (1) Specific | 2.3 | 2.7 | n.d. | 2.7 | ** | n.d. | 1.0 | 2.7 |
| volume after | | | | | | | | |
| storage 4 | | | | | | | | |
| weeks at | | | | | | | | |
| 35° C. | | | | | | | | |
| (j) pellet | 3 | 1 | n.d. | 0 | 5 | n.d. | 0 | 1 |
| formation | | | | | | | | |
| after 4 | | | | | | | | |
| weeks at | | | | | | | | |
| 35° C. | | | | | | | | |

n.d.: not determined
** Product could not be whipped at all

All samples were cooled to 5° C. for at least 24 hours before evaluation.

### CONCLUSION

Products according to the invention all fulfil tests (a-l). Products that are outside the claimed ranges do not fulfil all tests. If the C14 fatty acid content is too high (comparative example c2/c4) the emulsion shows several disadvantages upon storage such as pellet formation, grainy organoleptic behaviour, creaming and undesired viscosity increase (c4).

If the solid fat content is below the claimed range (comparative example c1), upon storage the emulsion shows creaming and an often undesired increase in whip time. None of these disadvantages were encountered for creams according to the invention.

1. Heat treated, whippable oil in water emulsion comprising 18-40 wt. % of fat phase calculated on total product weight and at least one emulsifier, characterised in that the fat phase substantially is a fat blend which has a solid fat content of at least 10% at 40° C. and at least 40% at 30° C. and at least 60% at 10° C., and the fat blend comprises from 5 to 49 wt % fatty acids with 14 carbon atoms or less on total fatty acid content of the fat blend.

2. Oil in water emulsion according to claim 1, wherein the fat blend shows a solid fat content of from 13% to 45% at 40° C., from 45% to 80% at 30° C. and at least 60% at 10° C.

3. Oil in water emulsion according to claim 1 or 2, wherein the fat blend comprises from 10 to 49 wt % fatty acids with 14 carbon atoms or less on total fatty acid content of the fat-blend.

4. Oil in water emulsion according to any of claims 1-3, wherein the fat blend is characterised by a difference (D) as defined herein between the solid fat content at 30° C. and the solid fat content at 35° C. of between 1% and 50%.

5. Oil in water emulsion according to any of claims 1-4, wherein the fat blend is characterised by a difference (D2) as defined herein between the solid fat content at 35° C. and the solid fat content at 20° C. of between 35% and 75%.

6. Oil in water emulsion according to any of claims 1-5, whereby the fat blend comprises fully hydrogenated fatty acids with 16 or 18 carbon atoms in addition to fatty acids with 14 carbon atoms or less.

7. Oil in water emulsion according to any of claims 1-6 wherein the fat blend comprises an interesterified fat blend, preferably an interesterified fat blend of fully hardened palmkernel oil and fully hardened palm oil or palm oil stearine.

8. Oil in water emulsion according to any of claims 1-7, whereby the emulsifier is present in an amount of from 0.01 to 1.5 wt %.

9. Oil in water emulsion according to any of claims 1-8, whereby the emulsifier is selected from the group comprising mono- di- or polyglycerides of fatty acids, calcium or sodium stearoyl lactylates and all sucrose esters thereof, esters of lactic, citric and tartaric acids with the mono- and diglycerides of fatty acids, polyoxyethylene ethers of sorbitan stearates, polyglycerol esters, lecithins and/or combinations thereof.

10. Oil in water emulsion according to any of claims 1-9, wherein a protein is present in a preferred amount of from 0.5 to 5 wt %.

11. Process for the preparation of an oil in water emulsion according to any of the preceding claims, wherein an emulsion of triglyceride fat and a premix comprising water, emulsifier and optionally an ingredient selected from the group comprising proteins, stabilisers, salts, sugar, flavour and combinations thereof, is prepared, heat treated at a temperature of from 70 to 160 ° C. for 1 second to 60 minutes, and filled into packaging material under aseptic conditions.

12. Emulsion according to any of claims 1-10 or prepared according to claim 11, which fulfils all tests (a) to (j) as defined herein.
